(19) United States
(12) Patent Application Publication
(10) Pub. No.: US 2022/0164763 A1
(43) Pub. Date: May 26, 2022

(54) DYNAMICALLY MAPPING DATA CENTERS USING MICRO-LOCATION RFID SENSORS

(71) Applicant: EMC IP Holding Company LLC, Hopkinton, MA (US)

(72) Inventor: Nicole Reineke, Northborough, MA (US)

(21) Appl. No.: 17/101,297

(22) Filed: Nov. 23, 2020

(51) Int. Cl. G06Q 10/08; H04W 4/029; H04W 4/02; G06K 19/07

(52) U.S. Cl. CPC G06Q 10/087; G06K 19/0723; H04W 4/023; H04W 4/029

(57) ABSTRACT

One example method includes generating a map of an environment. Microlocation sensors deployed to the environment read tags associated with assets in the environment. The positions of the tags are determined by the sensors and secondary information is accessed based on the identifiers read from the tags. A three-dimensional map of the environment is generated based on the positional data of the tags and the secondary information.

### FIELD OF THE INVENTION

Embodiments of the present invention generally relate to mapping. More particularly, at least some embodiments of the invention relate to systems, hardware, software, computer-readable media, and methods for dynamic map generation and mapping applications.

### BACKGROUND

Maps are used in a variety of different situations. For example, many data centers try to maintain a map of the assets in the data center in order to perform asset management. Unfortunately, these maps are typically generated manually. As a result, the resulting maps often include errors. In addition, manually generated maps are quickly obsolete and are difficult to update. In sum, manually mapping a data center (e.g., to determine locations of the assets therein) is often abandoned or is unmaintainable. This creates operational inefficiencies for customers, support personnel, and the business in general and also creates risks.

More specifically, mapping a data center often requires a person or persons to perform a visual inspection of the racks and of the assets mounted therein to collect the necessary information. After the information has been collected, there is still a need to generate the map itself. When changes occur to the assets in the data center, additional user intervention is required to ensure that the map is kept up to date. As previously stated, this process is prone to errors and is labor intensive.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of microlocation sensors and aspects of detecting tag locations in an environment;

FIG. 2 discloses aspects of determining relative positions of tags in an environment;

FIG. 3 discloses an example of a map of an environment such as a data center; and

FIG. 4 discloses aspects of a method for mapping an environment.

### DETAILED DESCRIPTION OF SOME EXAMPLE EMBODIMENTS

Embodiments of the present invention generally relate to mapping. More particularly, at least some embodiments of the invention relate to systems, hardware, software, computer-readable media, and methods for mapping and map related applications.

Tags such as radio frequency identifiers (RFIDs) are small and do not require a battery. RFIDs are increasingly used in a variety of manners. For example, tags are used in manufacturing. More specifically, tags are often added to servers, storage arrays, and other computing devices (generally referred to herein as assets or objects) or components thereof such that these assets can be shipped and tracked using RFIDs. Alternatively, these types of assets can be tagged at a later time, for example during deployment. These tags store data such as identifiers that uniquely identify the assets to which they are attached. Tags can be read by an appropriate sensor to retrieve the data stored thereon.

Tag sensors such as RFID microlocation sensors are capable of reading large numbers of RFIDs at the same time or at substantially the same time. These microlocation sensors can read the tags of moving assets and are not hampered by many materials (including some metals) and do not require a direct line of sight or access to the tag. In other words, microlocation sensors can read tags even when there is an object or material between the sensor and the tag. These microlocation sensors, by way of example only, may have a range of approximately 10 meters. Further, these microlocation sensors can determine the coordinates of the tag (e.g., (x,y,z) coordinates) within a margin of error or within a certain resolution.

Microlocation sensors can cooperate in or be connected in a mesh network to cover larger areas. Microlocation sensors, in addition, may be positioned in fixed locations or allowed to be mobile.

Embodiments of the invention use microlocation sensors to read the tags in an environment to determine the location of the tags in the environment. The data read from the tags (e.g., the identifier) can be correlated with secondary data such as asset size (e.g., dimensions), serial number, configuration, or the like. Embodiments of the invention further correlate this information with the locations and/or sizes of other objects that may not be tagged and/or other tagged assets in the environment.

Embodiments of the invention collect the tag information and determine the position the tags in the environment in order to determine relative locations of the tagged assets within the environment. This allows the entire environment (e.g., the locations of the tagged assets in the environment) to be mapped quickly and efficiently. This process can further be monitored and updated in real time. Plus, embodiments of the invention are also able to track movement of the tags (and of the assets to which they are attached) within the environment and implement various protocols related to the movement of the assets such as security protocols. For example, the movement of a particular server outside of a predefined area in the environment may trigger an alarm.

Because the identifiers and positions of the assets can be correlated with secondary information, embodiments of the invention may also be able to ensure that assets are installed correctly or in a predetermined manner, order, or location. Embodiments of the invention can be used for security purposes, for operating purposes, installation purposes, and the like. These operations can be performed in real or near-real time without human intervention once installed.

Embodiments of the invention are discussed in the context of a data center, which may include racks in which servers with tags are mounted. By deploying microlocation sensors in the data center environment, the locations of the tagged servers can be mapped. Movement of these assets can also be detected and tracked.

More specifically, embodiments of the invention can map the locations of assets in three dimensions. Mapping a data center may include mapping locations of assets (e.g., racks, servers, routers, switches or other hardware) in the data center. In addition, objects in the data center that may not be specific to the computing hardware may also be mapped (e.g., carts, tools). As previously stated, assets in the data center may be tagged with a tag during manufacture or production or may provisioned with a tag at another time, such as during deployment to a rack in a data center.

The assets may be mapped, and a map may be generated or rendered from the positional data. The map may be displayed on a user interface, delivered to a mobile device, or the like. In addition, the tags or their identifiers can be mapped to or correlated with secondary information. Secondary information may include, by way of example only, asset type, asset dimensions, serial number, asset characteristics or configuration, and the like. Because characteristics such as dimensions of the assets can be determined, the map may be augmented with graphics in order to provide a more pleasing view. Further, the map may be configured such that a user can drill down into specific areas of the environment.

When mapping an environment such as a data center, assets including racks, rack contents including servers and other assets may be mapped. The secondary information or the maps can also be augmented with information related to processes being performed by the assets. This allows a map of where various processes (including virtual machines or the like) are operating in the data center.

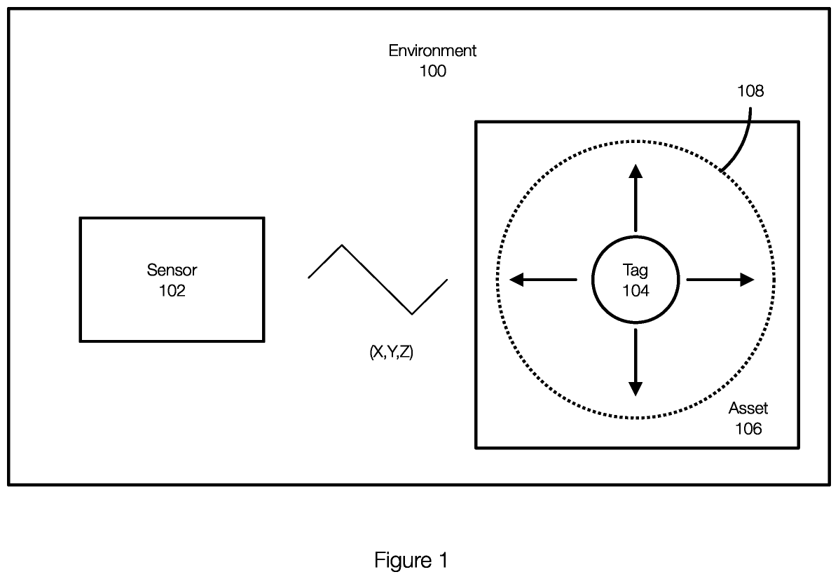

FIG. 1 illustrates an example of a microlocation sensor and tags in an environment. The environment 100 may be a data center. In this example, multiple microlocation sensors (represented by a sensor 102) are deployed in the environment 100. The sensors are typically deployed in a manner such that the space of the environment 100 is sufficiently covered and such that a tag, regardless of location in the environment 100, can be detected and read. Thus, the number of sensors 102 needed to map the environment 100 may depend on the size of the environment 100.

The assets in the environment 100 are each associated with a tag (represented by a tag 104 that is attached to an asset 106). During operation, the sensor 102 may detect the tag 104 of the asset 106 in the environment 100 and read information stored on the tag 104. The sensor 102 may be configured to determine a coordinate ((x,y,z)) or position of the asset 106 within the environment 100.

As illustrated in FIG. 1, the sensor 102 may actually detect a position 108 that is based on the abilities of the sensor 102. By way of example only, the position 108 represents the position of the asset 106 to within a margin of error or within a resolution of the sensor 102 (e.g., 6 inches). As discussed in more detail below, the process of generating a map includes a process to resolve the relative positions of assets based on the positional information determined by the sensor 102. Embodiments of the invention are also able to determine relative positions even when the tags are not placed on the same location of each asset.

Because the sensors in the environment may be networked (e.g., a mesh network) together, the positions or coordinates of all tagged assets can be determined rapidly.

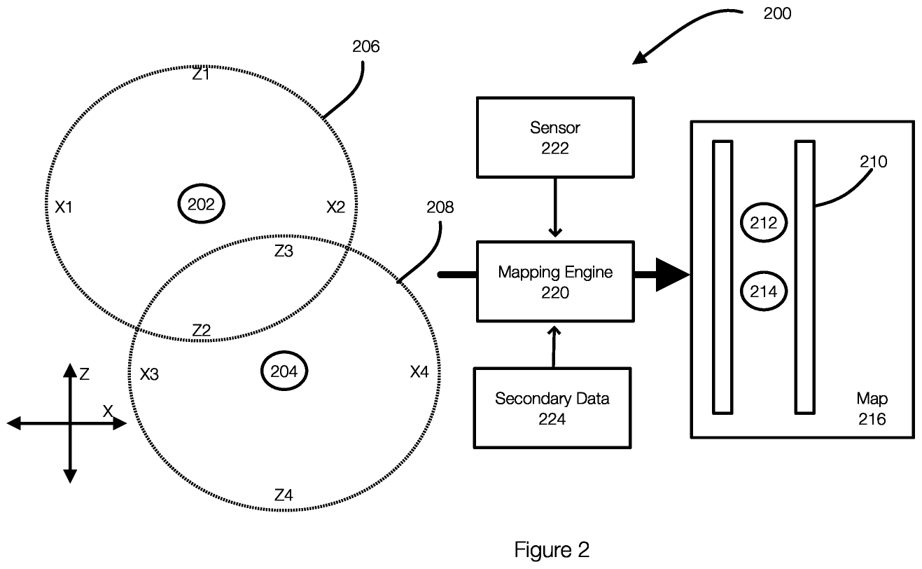

FIG. 2 illustrates an example of processing position data obtained from tags in an environment. FIG. 2 illustrates a tag 202 and a tag 204. Their positions were determined by a microlocation sensor 222 in the environment 200. The sensor 222 may determine the positions of the tags 202 and 204 in three dimensions and each of the tags 202 and 204 is associated with a coordinate (x,y,z) in the environment. More specifically, the sensor 22 may determine a potential coordinate range for each tag (e.g., (x1-x2, y1-y2, z1-z2). This effectively defines a space such as a sphere in which the tag is expected to be located. FIG. 2, however, only illustrates two dimensions for discussion purposes.

As shown in FIG. 2, the position of the tag 202 appears to be in the −X direction relative to the position of the tag 204. Similarly, the tag 204 is positioned in the −Z direction relative to the tag 202. The circle 206 represents that the tag 202 may actually be positioned anywhere within the circle 206 (e.g., within the resolution of the sensor 222) and the circle 208 represents that the tag 204 may be positioned anywhere within the circle 208.

The mapping engine 220 is configured to receive positional data of the tags 202 and 204 from the sensor 222. The mapping engine 220 may also have access to secondary data 224. With respect to the Z axis, the mapping engine 220 can determine that the tag 202 may be anywhere between Z1 and Z2. Similarly, the tag 204 may be positioned, in the Z direction, anywhere between Z3 and Z4.

The relative position of the tag 202 and the tag 204 (or the associated assets) can be determined using the circles 206 and 208 or using the coordinate ranges. More specifically, because Z1 is higher than Z3 (the maximum Z values for the tags 202 and 204), the mapping engine 220 can determine that the tag 202 is above the tag 204. When mapping, the tag 202 is thus positioned above the tag 204. With regard to the XY plane, the assets may be mapped to have essentially the same coordinates at least because they may be servers arranged in a rack. This type of information allows the assets to be positioned relative to other assets of the same and/or different types.

More specifically, the positional information can translate to a relative position in a rack 210, where the server 212 is positioned above the server 214 as illustrated in the map 216. When generating the map 216, the map reflects the positioning of the servers 212 and 214 relative to each other and relative to the rack 210. The map 216 may further reflect the locations of the racks, of rows of the datacenter, or the like.

In addition, the mapping engine 220, when generating the map, may use the secondary data 224 to account for more specific positioning. For example, the secondary data 224 can be accessed based on the identifiers obtained from the tags 202 and 204. The secondary data 224 may indicate that the server 212 is a 1U (1 rack unit, which is 1.75 inches) server and that the server 214 is 1U server. If no other tags are detected between the tags 202 and 204, the mapping engine can determine that the servers 212 and 214 are adjacent to each other in the rack 210. The rack 210 may also be associated with a tag such that its location relative to other racks can be determined if necessary. Alternatively, the positions of some assets (e.g., racks) could be inferred from the positions of the servers stacked therein.

Thus, the mapping engine 220 can use the position data from the sensor 222 (or sensors) describing the positions of assets in the environment 200 and the secondary data 224 to generate a map of the assets. Mapping the assets in this manner may also include matching the identifiers included in the position data to asset type, asset dimensions, rack dimensions, and the like. Further, the map can map the assets based on serial number and other asset characteristics. Even in a situation where identifiers of the racks are not available, the relative positions of the other assets can still be determined. This may allow the relative positions of the assets to be generated even without racks. The racks, in fact, could be inferred from the position data of the tagged assets.

The secondary data allows other checks, tests, or protocols to be performed. For example, the serial numbers can be checked to ensure that the asset sizes are in line with width and height expectations (e.g., 1U vs. 4U).

The tags allow the assets in the environment 200 to be positioned relative to each other in the environment 200 such that a map may be rendered. The secondary data 224 may enhance the map 210 and/or be used for other purposes.

The mapping engine 220, after receiving the positional data from the sensor (or sensors) and all tags in the environment 200, can generate a map 216 of the environment 200, which may be a data center. The map 216 may contain the positions of servers, racks, rows, and/or other tagged assets and/or untagged assets in the environment 200.

The map may refer to locations by data center location (rack, asset, position) or convert the position data to data center location (rack, asset, rack position) in the data center. In effect, embodiments of the invention correlate tag or RFID physical location with asset measurements to map the entire data center and its assets. The mapping engine 220 may be on-site or located in the cloud and may be accessible from various locations. The mapping engine 220 may be implemented as a physical machine, a virtual machine, a container, or in another manner.

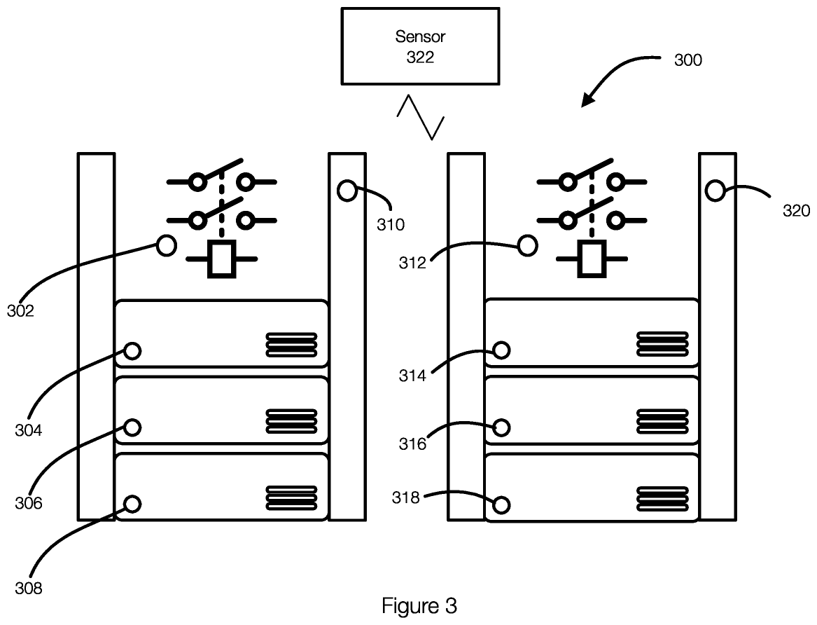

FIG. 3 illustrates an example of a map 300 that may be rendered or generated by the mapping engine. The map 300 may present the locations of assets based on tags. Thus, the positional information of the tags 302, 304, 306, 308, and 210, along with dimensional sizes of the associated assets obtained from the secondary information, allows a map illustrating a rack and servers and switches to be generated. Thus, the switches are positioned above the servers and the servers are sized (e.g., 1U, 2U) based on the secondary information. Similarly, the location of the sensor 322 and of the assets associated with the tags 312, 314, 316, 318, and 320 may also be shown in the map 300. Further, the map may allow a user to view which sensor read which tags as well as other information. For example, the map may include visual indicators that identify other characteristics of the assets obtained from the secondary information, such as brand, cores, memory, or the like. [0033] in preparing to generate a map of the environment such as a data center, some preliminary baseline calculations may be performed by the mapping engine. In one example, the grid to be used in mapping the data center is generated. This may be performed by examining the extremes of the X, Y, and Z coordinates of all detected tags. These coordinates may be determined relative to the microlocation sensors. By examining the extremes (e.g., the circles 206 and 208 in FIG. 2) of all detected tags, a grid can be established. For example, the tag in the most −X direction may establish an X position of 0, the tag in the most −Y direction may establish a Y position of 0, and the tag in the most −Z direction may establish a Z position of 0. With this reference, each an (x,y,z) coordinate can be determined for each tag in the grid.

In another example, the locations of the microlocation sensors may define the (0,0,0) position and the corners of the grid and the positions of the tags are determined according to this grid.

The grid generated in this manner may be divided into grid units based on the smallest width and length of the detected assets. Each grid unit can then be mapped. For each grid unit, the width, length and height of all detected assets in that grid unit are determined. The assets may be drawn (e.g., using secondary source graphics). Z positions of the assets may be resolved as previously described within the grid unit. Further, it may be necessary to determine whether an asset is in the current grid unit or in relative proximity to the grid unit.

When movement of a tag is determined, the map is regenerated, and a notification may be generated. If a new tag is detected, the asset associated with that tag is added to the map or the map is regenerated. For example, an empty slot in a rack may be filled or an asset in the rack may be replaced. More specifically, changes in the signals detected or tags read by the microlocation sensors may be measured over time. Movement of assets can be detected. Asset removal, asset failure, or the like can be correlated to tag silence.

Embodiments of the invention may also be used to detect unexpected or unauthorized asset movement. For example, a large department store may map the positions of assets such as point of sale (POS) devices such as card readers. If these assets move out of a predefined location (e.g., more than 5 ft from their current position), a notification may be made to a manager or security office. Thus, embodiments of the invention may prevent or deter theft in this manner.

One of skill in the art can appreciate, with the benefit of the present disclosure, that the map can be generated in other manners.

In one example when generating the map, all assets may be detected with respect to an XY axis or plane. The height of each asset may also be determined. The interference in the Z axis (or other axis) may also be resolved.

Embodiments of the invention advantageously eliminate the need to visually inspect the racks, perform an in-person inventory, read QR codes with drones or the like, or use computer vision techniques.

For example, an entity may have a data center of 2000 square feet. The data center includes various platforms, servers, storage, and arrays. Each of these assets includes or is associated with a tag such as an RFID tag. After installing sufficient microlocation sensors, the microlocation sensors or the mapping engine can determine the (0,0,0) position and the corners of the grid to create a baseline map of the detected area. Next, the RFID tags can be sensed and the position data and identifiers can be used to generate a map of the assets in the environment, which may include a physical rack layout with in-rack assets, with U location relative to other in-rack assets. This information can be generated for all rows and racks in the data center.

Assets are added to the map when a new tag is discovered. Assets that no longer appear on the mesh network are marked as missing or orphaned. Assets whose location changes can be associated with metadata such as time of move, old location, new location, or the like. This allows the entity to visualize their current state, past state, and changes over time.

In another example, the same entity may have data centers at multiple locations. Embodiments of the invention are able to collect data from each map of each location and generate a larger map that reflects the geographic location of each data center. This allows, for example, a central office, to generate a map that includes a multiple geographically distinct locations in the same map. The map may allow a user to view all installations on a geographic map and may allow the user to drill down into specific data centers on the map.

Another example illustrates how various characteristics, such as physical dimensions, are gathered and included in the secondary data. In one example, RFID tags are included on assets and sub-components of assets for various purposes including inventory tracking during the manufacturing process.

In addition, during the manufacturing process, a unique build of material is also created in order to fulfill customer orders.

The manufacturing process may proceed as follows.

First, the buyer may place an order. The bill of materials associated with the order is then sent to or received by the vendor. The bill of materials may contain all details for all components of an order. This may include the specific dimensions of the components or parts.

Next, the physical assets are built. Materials with an RFID tag are scanned and associated with the buyer order.

The vendor may maintain records that associates the RFID tags with specific materials or component. When a server computer is built, for example, information that relates the characteristics of the server to the RFID tag is generated and stored. Thus, the dimensions of the server, the configuration of the server, and other characteristics are associated with the RFID tag. This allows the vendor to understand which hardware is installed at the customer site and the vendor, for at least support purposes, can also establish connections between the asset, its dimensions, other characteristics and the associated RFID.

The vendor may also export this information to the end user such that the customer may include the information in their 3D generation software. The customer or end user may have access to secondary information stored by the customer or through the vendor.

Next, the mapping engine is installed at the customer's site. During installation, the buyer stores the data received from the vendor or connects to the vendor's database such that the mapping engine has access to the secondary information or data. Thus, the user can maintain the secondary information or access the secondary information from the vendor's database.

A mesh of microlocation sensors is also installed and the locations of the RFID tags are determined. The secondary data can be used to determine asset type and dimension. The mapping engine can then generate a map of the data center.

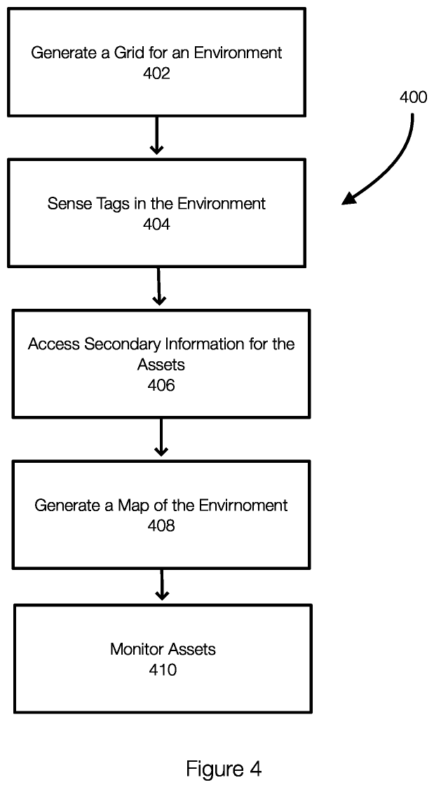

FIG. 4 illustrates an example of a method for mapping an environment. Some of the elements of FIG. 4 may be performed a single time or less frequently than other elements. For example, installing the microlocation sensors is typically performed a single time, although the microlocation sensors could be rearranged, updated, or the like.

The method 400 may begin, assuming that the various components (the mapping engine, the microlocation sensors) are installed, by generating 402 a grid for the environment. The grid typically defines a space in terms of (x,y,z) coordinates. As previously stated, this is an element than may be performed less frequently.

Once the grid is established, the tags in the environment are sensed 404 by the microlocation sensors. Sensing the tags may include reading the information stored on the tags and determining the positions of the tags within the previously established grid. In one example, the microlocation sensors determine the positional data of the tags and provides this information to the mapping engine.

The mapping engine may access 406 secondary information for the assets based on the identifiers read from the tags. This allows the mapping engine to acquire information such as asset type, asset dimensions, or the like for at least mapping purposes. The secondary information and the positional information allow the mapping engine to map the assets in the environment and allows the mapping engine to account for various characteristics such as asset dimensions.

With this information, the mapping engine may generate 408 a map of the environment. The map may be interactive and allow users to drill down to various areas and the like.

Next, the assets are monitored 410 by the mapping engine or by another component. Monitoring 410 includes various aspects such as detecting asset movement, generating a history (old asset location, time of movement, new asset location), generating notifications or alarms (e.g., when as asset moves out of a predetermined area), updating the map when new assets are detected or assets are moved, or assets are no longer detected, and the like or combination thereof.

In another example, the mapping may be able to identify incorrect asset placement or to optimize asset placement. For example, a detected asset may be associated with secondary information suggesting that the asset should be placed at the top of the rack. If the asset is at the bottom of the rack, a notification can be generated. Thus, the ability to map assets at a location can also be used to optimize asset placement and/or performance.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, mapping operations and mapping related operations. More generally, the scope of the invention embraces any operating environment in which the disclosed concepts may be useful.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a data center which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, or virtual machines (VM)

Particularly, devices in the operating environment may take the form of software, physical machines, or VMs, or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. AVM may be based on one or more computer architectures and provides the functionality of a physical computer. A VM implementation may comprise, or at least involve the use of, hardware and/or software. An image of a VM may take the form of a .VMX file and one or more .VMDK files (VM hard disks) for example.

As used herein, the term ‘data’ is intended to be broad in scope. Thus, that term embraces, by way of example and not limitation, data segments such as may be produced by data stream segmentation processes, data chunks, data blocks, atomic data, positional data, metadata, emails, objects of any type, files of any type including media files, word processing files, spreadsheet files, and database files, as well as contacts, directories, sub-directories, volumes, and any group of one or more of the foregoing.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted.

Following are some further example embodiments of the invention. These are presented only by way of example and are not intended to limit the scope of the invention in any way.

Embodiment 1. A method comprising: sensing tags in an environment, wherein each of the tags is associated with an asset in the environment, to determine positional data for each of the tags, accessing secondary information based on identifiers from the tags, wherein the secondary information includes asset dimensions, and generating a map of environment based at least on the positional data for each of the tags and based on the asset dimensions of the sensed tags.

Embodiment 2. The method of embodiment 1, further comprising deploying microlocation sensors in the environment that are configured to read the tags, the microlocation sensors configured to determine the positional data for each of the tags.

Embodiment 3. The method of embodiment 1 and/or 2, further comprising generating a grid of the environment, wherein the positional data is determined with respect to the grid and wherein the positional data of each tag includes an (x,y,z) coordinate.

Embodiment 4. The method of embodiment 1, 2, and/or 3, further comprising resolving interferences between the positional data of at least two tags.

Embodiment 5. The method of embodiment 1, 2, 3, and/or 4, further comprising dividing the map into grid areas, where the grid areas are sized based on the smallest asset dimensions.

Embodiment 6. The method of embodiment 1, 2, 3, 4, and/or 5, further comprising monitoring the assets.

Embodiment 7. The method of embodiment 1, 2, 3, 4, 5, and/or 6 wherein monitoring the assets includes detecting asset movement within the environment, detecting new assets added to the environment, and detecting assets removed from the environment.

Embodiment 8. The method of embodiment 1, 2, 3, 4, 5, 6, and/or 7, further comprising implementing security protocols for an asset and generating a notification if the asset moves out of a predefined area in the environment.

Embodiment 9. The method of embodiment 1, 2, 3, 4, 5, 6, 7, and/or 8, further comprising generating the secondary information during manufacture of the assets.

Embodiment 10. The method of embodiment 1, 2, 3, 4, 5, 6, 7, 8, and/or 9, further comprising regularly updating the map and/or optimizing asset placement.

Embodiment 11. A method for performing any of the operations, methods, or processes, or any portion of any of these, disclosed herein.

Embodiments 12. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

Any one or more of the entities disclosed, or implied, by the Figures and/or elsewhere herein, may take the form of, or include, or be implemented on, or hosted by, a physical computing device. As well, where any of the aforementioned elements comprise or consist of a virtual machine (VM), that VM may constitute a virtualization of any combination of the physical components disclosed herein.

In one example, the physical computing device (e.g., server) includes a memory which may include one, some, or all, of random access memory (RAM), non-volatile memory (NVM) such as NVRAM for example, read-only memory (ROM), and persistent memory, one or more hardware processors, non-transitory storage media, UI device, and data storage. One or more of the memory components of the physical computing device may take the form of solid-state device (SSD) storage. As well, one or more applications may be provided that comprise instructions executable by one or more hardware processors to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, data center, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method, comprising:
sensing tags in an environment, wherein each of the tags is associated with an asset in the environment, to determine positional data for each of the tags, wherein a line of sight to the tags is not required to determine the positional data of the tags;
accessing secondary information based on identifiers from the tags, wherein the secondary information includes asset dimensions;
generating a map of environment based at least on the positional data for each of the tags and based on the asset dimensions of the sensed tags; and
resolving relative positions of the assets in the environment using the positional data of the tags and resolutions of the tags.

2. The method of claim 1, further comprising deploying microlocation sensors in the environment that are configured to read the tags, the microlocation sensors configured to determine the positional data for each of the tags.

3. The method of claim 1, further comprising generating a grid of the environment, wherein the positional data is determined with respect to the grid and wherein the positional data of each tag includes an (x,y,z) coordinate.

4. (canceled)

5. The method of claim 1, further comprising dividing the map into grid areas, where the grid areas are sized based on the smallest asset dimensions.

6. The method of claim 1, further comprising monitoring the assets.

7. The method of claim 6, wherein monitoring the assets includes detecting asset movement within the environment, detecting new assets added to the environment, and detecting assets removed from the environment.

8. The method of claim 6, further comprising implementing security protocols for an asset and generating a notification if the asset moves out of a predefined area in the environment.

9. The method of claim 1, further comprising generating the secondary information during manufacture of the assets.

10. The method of claim 1, further comprising regularly updating the map.

11. A non-transitory storage medium having stored therein instructions that are executable by one or more hardware processors to perform operations comprising:
sensing tags in an environment, wherein each of the tags is associated with an asset in the environment, to determine positional data for each of the tags, wherein a line of sight to the tags is not required to determine the positional data of the tags;
accessing secondary information based on identifiers from the tags, wherein the secondary information includes asset dimensions;
generating a map of environment based at least on the positional data for each of the tags and based on the asset dimensions of the sensed tags; and
resolving relative positions of the assets in the environment using the positional data of the tags and resolutions of the tags.

12. The non-transitory storage medium of claim 11, further comprising deploying microlocation sensors in the environment that are configured to read the tags, the microlocation sensors configured to determine the positional data for each of the tags.

13. The non-transitory storage medium of claim 11, further comprising generating a grid of the environment, wherein the positional data is determined with respect to the grid and wherein the positional data of each tag includes an (x,y,z) coordinate.

14. (canceled)

15. The non-transitory storage medium of claim 11, further comprising dividing the map into grid areas, where the grid areas are sized based on the smallest asset dimensions.

16. The non-transitory storage medium of claim 11, further comprising monitoring the assets.

17. The non-transitory storage medium of claim 16, wherein monitoring the assets includes detecting asset movement within the environment, detecting new assets added to the environment, and detecting assets removed from the environment.

18. The non-transitory storage medium of claim 16, further comprising implementing security protocols for an asset and generating a notification if the asset moves out of a predefined area in the environment.

19. The non-transitory storage medium of claim 11, further comprising generating the secondary information during manufacture of the assets.

20. The non-transitory storage medium of claim 11, further comprising optimizing asset placement.
